(19) United States
(12) Patent Application Publication
(10) Pub. No.: US 2020/0367000 A1
(43) Pub. Date: Nov. 19, 2020

(54) HEARING INSTRUMENT

(71) Applicant: SIVANTOS PTE. LTD., SINGAPORE (SG)

(72) Inventors: KUNIBERT HUSUNG, ERLANGEN (DE); HARTMUT RITTER, NEUNKIRCHEN (DE)

(21) Appl. No.: 16/863,050

(22) Filed: Apr. 30, 2020

(30) Foreign Application Priority Data
May 14, 2019 (DE) 102019207008

(51) Int. Cl. H04R 25/00; H01M 10/42; H01M 10/0525; H01M 2/10; H01M 10/46

(52) U.S. Cl. CPC H04R 25/602; H01M 10/425; H01M 10/0525; H01M 2/1055; H04R 2225/31; H04R 25/554; H01M 2220/30; H04R 2225/021; H04R 2225/025; H01M 10/46

(57) ABSTRACT

A hearing instrument includes a rechargeable battery and an inductive transmitting and/or receiving coil. The battery is configured as a layer stack and the battery has a lamination direction. The transmitting and/or receiving coil is disposed in such a way that its axis is oriented perpendicular to the lamination direction of the battery.

### CROSS-REFERENCE TO RELATED APPLICATION

This application claims the priority, under 35 U.S.C. § 119, of German Patent Application DE10 2019 207 008, filed May 14, 2019; the prior application is herewith incorporated by reference in its entirety.

### BACKGROUND OF THE INVENTION

### Field of the Invention

The present invention relates to a hearing instrument including a rechargeable battery and a (magnetically) inductive transmitting and/or receiving coil.

The term “hearing instrument” generally refers to devices which pick up ambient sound, modify it through signaling technology, and emit a modified acoustic signal to the ear of a person (“wearer”) wearing the hearing instrument. A hearing instrument which is constructed for providing for a hearing-impaired wearer and which processes, in particular amplifies, the acoustic environment signal in such a way that the hearing impairment is completely or partially compensated for, is referred to herein and below as a “hearing aid.” For this purpose, a hearing aid typically includes an input transducer, for example, in the form of a microphone, a signal processing unit having an amplifier, and an output transducer. The output converter is generally implemented as a miniature loudspeaker and is also referred to as a “receiver.”

However, in addition to hearing aids, there are also hearing instruments which are geared towards providing for people with normal hearing, in order to protect the hearing of the wearer, or to facilitate perception under noisy conditions (for example, understanding speech in complex noisy environments) for certain purposes. Such hearing instruments are often constructed like hearing aids and also include in particular the aforementioned components: input transducer, signal processor, and output transducer.

In order to meet the many individual needs, different constructions of hearing instruments are provided. In so-called BTE (behind-the-ear) hearing instruments, a housing which is populated with the input transducer, the signal processor, and a battery is worn behind the ear. Depending on the construction, the output transducer may be disposed directly in the auditory canal of the wearer (so-called receiver-in-the-canal (RIC) hearing instruments). Alternatively, the output transducer is disposed inside the housing itself. In that case, a flexible sound tube, which is also referred to as a “tube,” conducts the acoustic output signals of the output transducer from the housing to the auditory canal (sound tube hearing instruments). In the case of so-called ITE (in-the-ear) hearing instruments, a housing, which contains all functional components including the input transducer and the output transducer, is worn at least partially in the auditory canal. So-called CIC (completely-in-canal) hearing instruments are similar to the ITE hearing instruments, but are worn completely in the auditory canal.

Due to the increasing number of integrated functions, hearing instruments have an increasing energy demand which cannot be satisfactorily met with the non-rechargeable batteries which are in common use today.

Efforts are therefore being made to employ high-performance rechargeable batteries, in particular lithium-ion (Li-ion) batteries, as a power source for hearing instruments. However, such rechargeable batteries generate parasitic magnetic fields and may therefore interfere with the inductive transmitting and/or receiving coils (for example, telephone coils or inductive transceivers for wireless communication between the hearing instrument and a peripheral device) which are often integrated into hearing instruments, in particular hearing aids. The simultaneous and interference-free configuration of a rechargeable battery and an inductive transmitting and/or receiving coil in a hearing instrument housing is therefore complicated, and in many cases, even impossible, due to the highly restricted space in the housing of a hearing instrument.

### SUMMARY OF THE INVENTION

It is accordingly an object of the invention to provide a hearing instrument, which overcomes the hereinafore-mentioned disadvantages of the heretofore-known devices of this general type, which has a compact configuration of a high-power rechargeable battery and an inductive transmitting and/or receiving coil and in which an undesirable influence on the transmitting and/or receiving coil by the battery is to be prevented or at least largely reduced.

With the foregoing and other objects in view there is provided, in accordance with the invention, a hearing instrument which, on one hand, includes a rechargeable battery and, on the other hand, an inductive transmitting and/or receiving coil (abbreviated as “coil” below). According to the present invention, the battery is configured in a so-called stack construction, i.e., as a layer stack. In contrast to wound batteries, in which one or more layers of the battery are wound around an inner electrode, the battery configured in a stack construction includes a plurality of layers which are stacked on top of one another in a layer direction (or stack direction). A layer plane (or stack plane) refers to a plane which is oriented orthogonal (i.e., at a right angle) to the direction of lamination. This lamination plane is parallel to the border layers at which adjacent layers of the battery, which is configured in a stack construction, abut one another.

In this case, the coil is disposed in such a way that its axis is oriented orthogonal to the lamination direction (i.e., in parallel with a lamination plane) of the battery. It is thereby achieved that the parasitic magnetic fields generated by the battery during the operation of the hearing instrument do not interfere with the coil, or interfere only to a very minor extent. In turn, this makes possible a particularly compact configuration of the battery and the coil in a housing of the hearing instrument. In particular, the coil can be disposed particularly close to the battery without the function of the coil being interfered with by the battery. Depending on the construction, magnetic shielding of the coil with respect to the battery is either completely unnecessary and therefore not present, or can be comparatively simply configured.

The battery is preferably configured in the form of a Li-ion battery.

The coil is in particular a telephone coil (telecoil) or an inductive transceiver. Telephone coils are constructed for the reception of magnetic alternating fields in the typical frequency range of audible sound waves (for example, approximately 100 Hz to 10 kHz) and are used for receiving acoustic information which has been directly converted into magnetic AC fields (for example, by using induction loops laid in churches or museums). Inductive transceivers are constructed for transmitting and/or receiving magnetic AC fields of higher frequencies, typically in the megahertz range. They are typically used for wireless information transmission between the hearing instrument and a peripheral device, for example, another hearing instrument for providing for the other ear of the wearer, a remote control, an external audio interface device, or an external microphone. The coil may furthermore also be an integral part of a magnetic sensor, for example, an electronic compass.

Preferably, the battery is disposed in the housing of the hearing aid in such a way that the lamination direction of the battery is oriented approximately in the viewing direction of the wearer, if the wearer wears the hearing instrument in the intended position in or on the ear. In this case, the viewing direction of the wearer refers to the horizontal direction lying in the plane of symmetry of the head when the head is held level, independently of the eye position of the wearer, so that the direction thus in particular is also oriented orthogonal to the transverse direction of the head (i.e., the straight-line connection between the ears of the wearer). This orientation of the battery is particularly advantageous, particularly since it makes possible an advantageous but also simultaneously interference-protected configuration of the coil. Thus, the coil is in particular disposed in such a way that its axis is oriented in the intended wearing position of the hearing instrument in or on the ear, both orthogonal to the lamination direction, i.e., also perpendicular in the ambient space (i.e., at a right angle to the ground). The perpendicular orientation of the coil axis makes possible in particular especially good reception if the coil is configured as a telephone coil. In a likewise advantageous alternative construction, the coil is disposed in such a way that its axis is oriented in the intended wearing position of the hearing instrument in or on the ear both orthogonal to the lamination direction and in parallel with the transverse direction of the head. The orientation of the coil axis in the transverse direction makes possible in particular particularly efficient signal transmission if the coil is configured as an inductive transceiver and is used for signal exchange with another hearing instrument worn on the other ear of the wearer.

According to the conventional construction, in an advantageous embodiment, the battery has two electrical connection contacts (battery poles). The structural unit formed from the two connection contacts is referred to below as a “contact configuration.” In an advantageous embodiment of the present invention, the two connection contacts are disposed at a distance from one another which is small compared to the longitudinal extent of the battery. In this case, the longitudinal extent is understood to be the magnitude of the longest edge or dimension of the battery. In particular, the distance between the two connection contacts is at most a third, preferably at most a fourth, of the longitudinal extent of the battery. In an additional advantageous embodiment, the two connection contacts are disposed next to one another in parallel with the axis of the coil (i.e., along a line which is parallel to the axis of the coil).

The coil is furthermore preferably positioned centered with respect to the contact configuration, as viewed transversely with respect to its axis, i.e., in particular in such a way that a geometrical center of the coil is equidistant from the two connection contacts of the battery.

In an advantageous embodiment, the coil is disposed in the vicinity of a bottom of the battery, i.e., in the vicinity of a side of the battery facing away from the connection contacts, since in this case, the current density inside the battery and in this respect, also the influence on the coil by the battery, are particularly low.

Advantageously, the battery generally has the shape of a common right mathematical cylinder having round or polygonal end faces and at least one side wall which is perpendicular thereto. In this case, the end faces are oriented perpendicular to the lamination direction (parallel to the lamination plane). In an embodiment which is particularly advantageous for use in the hearing device, the battery has the shape of a cuboid (which in this regard forms a special shape of the aforementioned right mathematical cylinder). In this construction, the battery has two end faces which are opposite one other in the lamination direction of the battery, two broad sides which are opposite one other (which are perpendicular to the end faces), and two narrow sides which are opposite one other (which are perpendicular to the end faces and the broad sides). The cuboid construction of the battery has in particular the advantage that as a result, comparatively many battery layers can be accommodated in a flat battery housing which can be integrated particularly well (i.e., optimized in terms of installation space) in the housing of the hearing instrument. In the case of the cylinder-shaped (in particular cuboid-shaped) battery described above, the two connection contacts are preferably disposed on one of the two end faces. Thus, in other words, the two connection contacts are disposed on the same end face.

In a particularly preferable embodiment of the present invention, the coil is disposed adjacent the side wall (or one of possibly several side walls) of the battery. In this case, each of the two connection contacts is disposed on the edge of an associated end face facing away from the battery. The connection contacts (in this case in particular in turn disposed on the same end face) are thus particularly far away from the coil, whereby the probability of interference with the coil by the battery is further reduced.

In the case of a cuboid-shaped battery, the coil is preferably disposed adjacent a narrow side of the battery, since on one hand, this is particularly advantageous for reasons of installation space optimization, and on the other hand, the coil may be disposed at a particularly large distance from the connection contacts of the battery in this way. Above all, this configuration is particularly advantageous for comparatively small coils, for example, inductive transceivers.

Particularly in the case of a comparatively large coil, in particular a telephone coil, on the other hand, for reasons of installation space optimization, an alternative embodiment of the present invention is preferred in which the coil is disposed adjacent one of the two broad sides of the cuboid-shaped battery. In this case, the coil is preferably positioned centered with respect to the broad side of the battery, as viewed transversely with respect to its axis.

The present invention described above is preferably used in a BTE hearing instrument. In this case, the battery and the coil are disposed in a housing which is to be worn behind the ear of the wearer. Generally, however, the present invention may also be used in hearing instruments constructed differently, in particular ITE hearing instruments or (completely or partially) implanted hearing instruments.

The hearing instrument is in particular a hearing aid constructed for providing for a hearing-impaired wearer, as described initially. In addition to the battery, the coil, and the housing, the hearing instrument preferably includes at least one input transducer (for example, in the form of a microphone), a signal processing unit including an (in particular digital) signal processor and/or an amplifier, and an output transducer (in particular a receiver). In this case, the output transducer is optionally integrated into the housing or disposed in an earpiece which is separate from the housing.

Other features which are considered as characteristic for the invention are set forth in the appended claims.

Although the invention is illustrated and described herein as embodied in a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view of a hearing instrument including a housing, an input transducer in the form of a microphone, a signal processing unit, an output transducer in the form of a receiver, and a rechargeable battery and an inductive (transmitting and/or receiving) coil;

FIG. 2 is a perspective view of an electronics frame of the hearing instrument which is disposed in the housing according to FIG. 1, and the battery, which is cuboid-shaped in this case, and the coil, in a first configuration;

FIG. 3 is a top-plan view of the configuration of the battery and the coil according to FIG. 2, as seen looking onto an end face of the battery carrying two connection contacts;

FIG. 4 is a view similar to FIG. 2, of the electronics frame and the battery, which is also cuboid-shaped in this case, and the coil of the hearing instrument according to FIG. 1, in a second configuration;

FIG. 5 is a view similar to FIG. 3, of the configuration of the battery and the coil according to FIG. 4;

FIG. 6 is a perspective view of the battery, which has the shape of a circular cylinder, and the coil which is positioned with respect to the battery; and

FIG. 7 is a plan view according to FIG. 3, of the configuration of the battery and the coil according to FIG. 6.

### DETAILED DESCRIPTION OF THE INVENTION

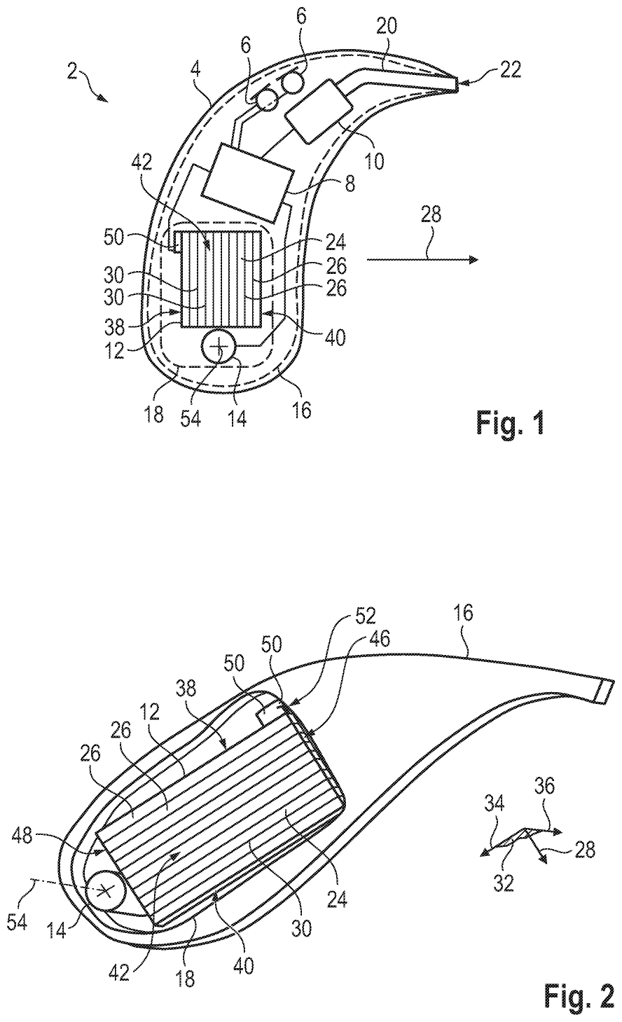

Referring now in detail to the figures of the drawings, in which corresponding parts and dimensions are always provided with identical reference characters, and first, particularly, to FIG. 1 thereof, there is seen a rough diagrammatic representation of a hearing instrument 2 in the form of a (BTE) hearing aid.

The hearing instrument 2 includes a housing 4 to be worn behind the ear of a hearing-impaired wearer, in which two input transducers 6 in the form of microphones, a signal processing unit 8 including a signal processor and/or a microcontroller, an output transducer 10 in the form of a receiver, and a rechargeable battery 12, are disposed as main components. The battery 12 is a Li-ion battery. The hearing instrument 2 further includes a (magnetically) inductive coil 14 for transmitting and/or receiving magnetic AC signals.

A majority of the electrical and electronic components of the hearing instrument 2, in particular the input transducer 6, the signal processing unit 8, and the output transducer 10, are mounted on an electronics frame 16. The electronics frame 16 is a frame in particular made of plastic which is fabricated separately from the housing 4 and on which the aforementioned electrical and electronic components can be premounted outside the housing 4. The battery 12 and/or the coil 14 are preferably also attached in or to the electronics frame 16. In particular, the battery 12 and the coil 14 are inserted into a recess 18 of the electronics frame 16 in such a way that the battery 12 and the coil 14 are fixed in a defined relative position with respect to one other and with respect to the housing 4.

During the operation of the hearing device 2, an acoustic signal is picked up from the environment of the hearing instrument 2 by using the input transducer 6 and is output to the signal processing unit 8 as an audio signal (i.e., as an electrical signal carrying sound information). The signal processing unit 8 is used to process, in particular amplify, the audio signal which is picked up as a function of frequency in order to compensate for the hearing loss of the wearer. The signal processing unit 8 outputs a modified audio signal resulting from this processing to the output transducer 10. The transducer in turn converts the modified audio signal into an acoustic signal. This acoustic signal (which is modified with respect to the sound picked up from the environment) is initially conducted from the output transducer 10 through a sound channel 20 to a tip 22 of the housing 4, and from there through a sound tube, which is not explicitly depicted, into the ear of the wearer.

In the embodiment according to FIG. 1, the coil 14 is configured as an inductive transceiver for data exchange with a second hearing instrument, wherein this second hearing instrument is worn on the other ear of the wearer. For this purpose, the coil 14 is configured for transmitting and receiving magnetic AC signals in the megahertz range (for example, at a frequency of 3.3 MHz).

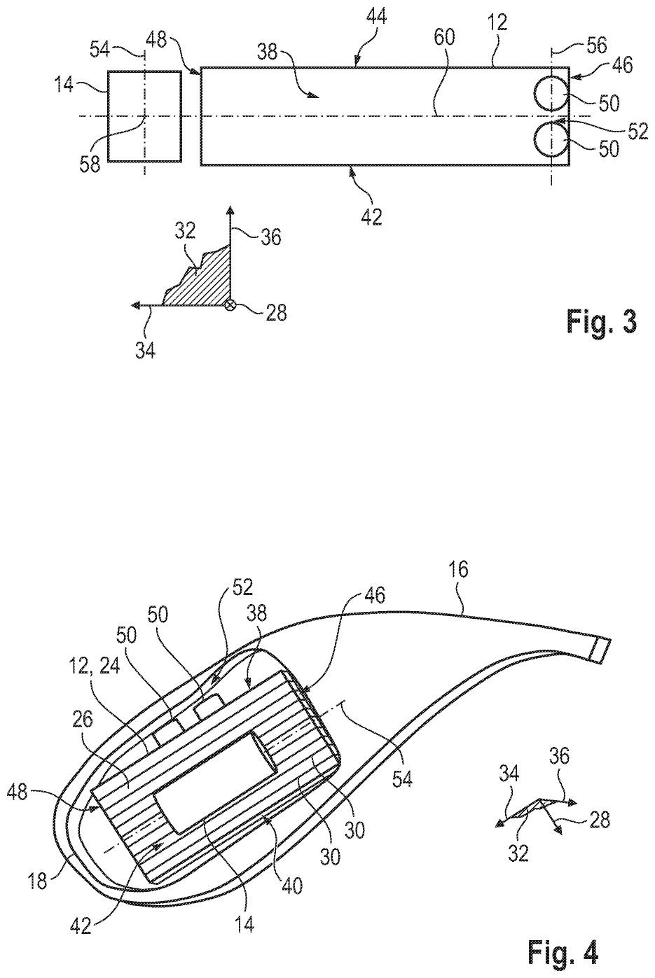

The battery 12 is configured in a stack construction, i.e., as a layer stack 24. It accordingly includes a plurality of active layers 26 which are stacked on top of one another in a lamination direction 28. In this case, the layers 26 of the battery 12 lie on interfaces 30 of one another which are oriented in parallel with a lamination plane 32 (for example, depicted in FIGS. 2 and 3). This lamination plane 32 is orthogonal to the lamination direction 28, and in a coordinate system depicted in FIGS. 2 and 3, the lamination plane 32 is spanned by two directions which are orthogonal to one another and to the lamination direction 28, i.e., a longitudinal direction 34 and a transverse direction 36.

In the exemplary embodiment depicted in FIGS. 1 to 3, the battery 12 has the shape of a cuboid having two end faces 38 and 40 which are opposite one another in the lamination direction 28. The two end faces 38 and 40 are respectively oriented orthogonal to the lamination direction 28 (therefore in parallel with the lamination plane 32) and are connected through four side walls, in particular two broad sides 42 and 44 which are opposite one another (FIG. 3) and two narrow sides 46 and 48 which are opposite one other.

The battery 12 has two electrical connection contacts 50 which are both disposed next to one another on the end face 38. In summary, the assembly formed by the connection contacts 50 is also referred to as a contact configuration 52 (FIG. 2). In this case, the connection contacts 50 are disposed on an edge of the end face 38 which is adjacent the narrow side 46 facing the tip 22 of the housing 4.

In order to avoid an undesirable influence on the coil 14 due to the parasitic magnetic fields generated by the battery 12 during the operation of the hearing instrument 2, or at least to keep it as low as possible, the coil 14 is disposed adjacent the narrow side 48 of the battery 12 facing away from the tip 22 of the housing 4. The coil 14 is thus comparatively far away from the connection contacts 50 of the battery 12. In addition, the coil 14 is disposed in such a way that its axis 54 (FIG. 3) is oriented in parallel with the transverse direction 36, and thus orthogonal to the lamination direction 28 (therefore in parallel with the lamination plane 32).

An influence on the coil 14 by the battery 12 is further reduced in that the two connection contacts 50 are disposed at a distance from one another which is small with respect to the longitudinal extent of the battery 12. In the example according to FIGS. 1 to 3, the distance between the connection contacts 50 measured along a connecting line 56 is only approximately one seventh of the longitudinal extent of the battery 12, which is formed in this case by the length of the edge of the battery 12 running in the longitudinal direction 34. In addition, the two connection contacts 50 are disposed next to one another in parallel with the axis 54 of the coil 14. In other words, the connecting line 56 between the connection contacts 50 is oriented in parallel with the axis 54 of the coil 14. Finally, viewed transversely with respect to its axis 54, the coil 14 is positioned centered with respect to the contact configuration 52, i.e., in such a way that the geometrical center 58 of the coil 14 is disposed at the same distance from the two connection contacts 50 of the battery 12, and a plane of symmetry 60 of the contact configuration 52 which is orthogonal to the connecting line 56 intersects the coil 14 in its geometrical center 58. Thus, the coil 14 is disposed in such a way that it is disposed orthogonal and centered with respect to the parasitic magnetic fields caused by circulating currents in the battery 12, whereby interactions of these magnetic fields with the coil 14 are excluded or at least largely reduced.

In the intended wearing position of the hearing instrument 2 on the ear of the wearer, the battery 12 is oriented in such a way that its lamination direction 28 is oriented exactly or at least approximately in parallel with the viewing direction of the wearer. The axis 54 of the coil 14 which is perpendicular thereto is thus oriented exactly or at least approximately in the transverse direction of the head, and is thus aligned with the second hearing instrument worn on the other ear of the wearer. Effective data transmission between the two hearing instruments is thereby ensured.

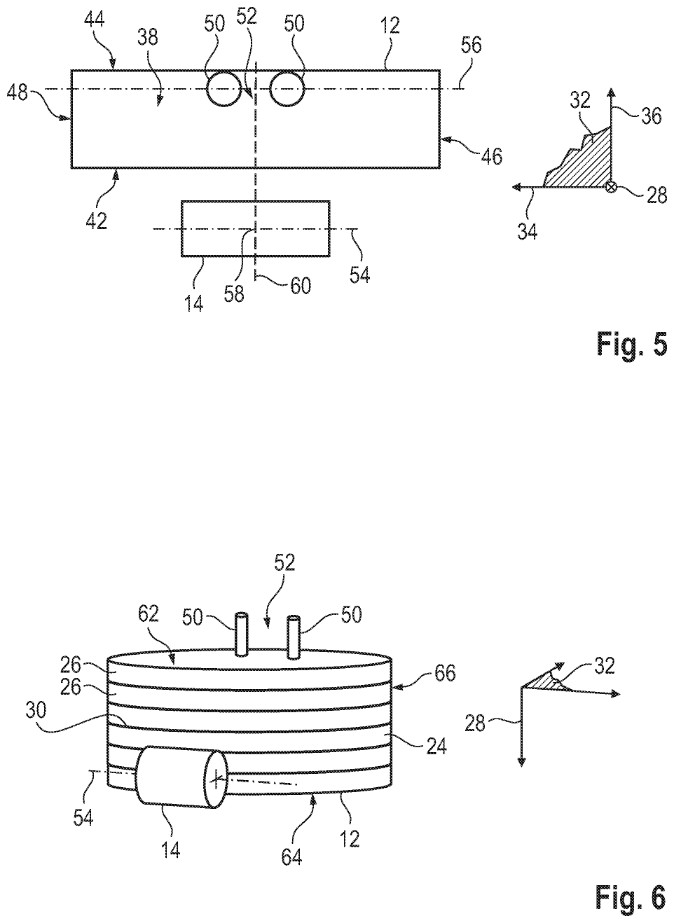

FIGS. 4 and 5 depict a second embodiment of the hearing instrument 2 in which the coil 14 is configured as a telephone coil. Due to the size of the coil 14, which is considerably greater in this case, and due to the desired orientation of the coil 14 in the wearing position of the hearing instrument 2, the coil 14 in the example according to FIGS. 4 and 5 is disposed adjacent the broad side 44 of the battery 12. As in the above example, the axis 54 of the coil 14 is thus oriented orthogonal to the lamination direction 28 (therefore, in parallel with the lamination plane 32). In addition, in this case as well, the distance between the connection contacts 50 is small with respect to the longitudinal extent of the battery 12 and, in this case, it corresponds approximately to one fifth of the longitudinal extent of the battery 12.

In addition, in the example according to FIGS. 4 and 5, the two connection contacts 50 are also disposed next to one another in parallel with the axis 54 of the coil 14. Likewise, the coil 14 is in turn positioned centered with respect to the contract configuration 52, as viewed transversely with respect to its axis (see FIG. 5).

In the intended wearing position of the hearing instrument 2, the axis 54 of the coil 14 which is orthogonal to the lamination direction 28 of the battery 12 is exactly or at least approximately oriented perpendicular in space, and thus is oriented toward the ground. Thus, an effective reception of magnetic AC signals which are emitted by induction loops which are typically laid in the ground, is made possible.

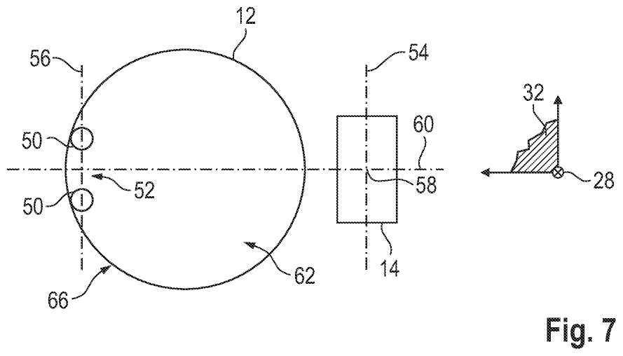

In FIGS. 6 and 7, a third embodiment of the hearing instrument 2 is depicted in which the battery 12 has a circular-cylindrical shape. In this case, the battery 12 in turn has two round end faces 62 and 64 which are opposite one another in the lamination direction 28 and are connected to one another by a circumferential wall 66.

In this case, the two connection contacts 50 are disposed on an edge of the end face 62. The coil 14 is disposed adjacent the circumferential wall 66, opposite the connection contacts 50, so that its axis 54 is in turn oriented perpendicular to the lamination direction 28 of the battery 12.

As in the above exemplary embodiments, in the example according to FIGS. 6 and 7, the two connection contacts 50 are also disposed next to one another in parallel with the axis 54 of the coil 14, wherein the distance between the connection contacts 50 is in turn small with respect to the longitudinal extent of the battery 12 and, in this case, it corresponds to approximately one fourth of the longitudinal extent of the battery 12, wherein the longitudinal extent is provided in this case by the diameter. Likewise, the coil 14 is in turn positioned centered with respect to the contact configuration 52, as viewed transversely with respect to its axis 54 (see FIG. 7).

As is apparent from FIG. 6, in this case, the coil 14 is furthermore disposed near a floor of the battery 12 (i.e., near the end face 64 facing away from the connection contacts 50). In this area of the battery 12, during the operation of the hearing instrument 2, the current density is comparatively low, whereby the strength of the parasitic magnetic fields emitted by the battery 12 is also comparatively low in this case. However, for structural reasons, in most cases, the coil 14 is disposed symmetrically.

The present invention is made particularly clear based on the exemplary embodiments described above. However, it is nonetheless not limited to these exemplary embodiments. Rather, further embodiments of the present invention may be derived from the claims and the description.

### LIST OF REFERENCE CHARACTERS

2 Hearing instrument
4 Housing
6 Input transducer
8 Signal processing unit
10 Output transducer
12 Battery
14 Coil
16 Electronics frame
18 Opening
20 Sound channel
22 Tip
24 Layer stack
26 Layer
28 Lamination direction
30 Interface
32 Lamination plane
34 Longitudinal direction
36 Transverse direction
38 End face
40 End face
42 Broad side
44 Broad side
46 Narrow side
48 Narrow side
50 Connection contact
52 Contact configuration
54 Axis
56 Connecting line
58 Center
60 Plane of symmetry
62 End face
64 End face
66 Circumferential wall

1. A hearing instrument, comprising:
a rechargeable battery configured as a layer stack defining a lamination direction of said battery; and
a coil configured as at least one of an inductive transmitting or receiving coil, said coil having an axis oriented perpendicular to said lamination direction.

2. The hearing instrument according to claim 1, which further comprises a housing, said battery being disposed in said housing in a position causing said lamination direction to be oriented exactly or approximately in parallel with a viewing direction of a person wearing the hearing instrument in an intended wearing position in or on one of the ears of the person.

3. The hearing instrument according to claim 1, wherein said battery includes a contact configuration having two electrical connection contacts.

4. The hearing instrument according to claim 3, wherein said battery has a longitudinal extent, and said connection contacts are disposed at a distance from one another being at most one third of said longitudinal extent of said battery.

5. The hearing instrument according to claim 3, wherein said battery has a longitudinal extent, and said connection contacts are disposed at a distance from one another being at most one fourth of said longitudinal extent of said battery.

6. The hearing instrument according to claim 3, wherein said coil has an axis, and said two connection contacts are disposed next to one another in parallel with said axis of said coil.

7. The hearing instrument according to claim 3, wherein said coil has an axis, and said coil is in a centered positioned relative to said contact configuration transversely relative to said axis of said coil.

8. The hearing instrument according to claim 3, wherein said battery has a generally right cylindrical shape with two circular or polygonal end faces disposed opposite one another in said lamination direction and at least one side wall (42, 44, 46, 48, 66) perpendicular to said end faces.

9. The hearing instrument according to claim 8, wherein said battery is cuboid-shaped and said at least one side wall includes two broad sides disposed opposite one other and two narrow sides disposed opposite one other.

10. The hearing instrument according to claim 8, wherein said two connection contacts are disposed on one of said two end faces.

11. The hearing instrument according to claim 9, wherein said two connection contacts are disposed on one of said two end faces.

12. The hearing instrument according to claim 10, wherein said coil is disposed adjacent a side wall of said battery, and each of said two connection contacts is disposed on an edge of an associated end face facing away from said coil.

13. The hearing instrument according to claim 11, wherein said coil is disposed adjacent a side wall of said battery, and each of said two connection contacts is disposed on an edge of an associated end face facing away from said coil.

14. The hearing instrument according to claim 1, which further comprises a housing to be worn behind the ear of a person, said battery and said coil being disposed in said housing.

15. The hearing instrument according to claim 1, wherein said battery is a Li-ion battery.
